(19) United States
(12) Patent Application Publication
(10) Pub. No.: US 2025/0063238 A1
(43) Pub. Date: Feb. 20, 2025

(54) METHOD AND SYSTEM FOR VIDEO-STREAM BROADCASTING

(71) Applicant: Sunburn Capital L.L.C-FZ, Dubai (AE)

(72) Inventor: Mikko Spoof, Dubai (AE)

(21) Appl. No.: 18/820,869

(22) Filed: Aug. 30, 2024

Related U.S. Application Data
(63) Continuation of application No. PCT/IB2024/054436, filed on May 7, 2024.

(30) Foreign Application Priority Data
May 26, 2023 (FI) 20235584

(51) Int. Cl. H04N 21/854; H04N 21/234; H04N 21/266; H04N 21/442; H04N 21/472; H04N 21/81

(52) U.S. Cl. CPC H04N 21/854; H04N 21/23412; H04N 21/266; H04N 21/44213; H04N 21/472; H04N 21/8146

(57) ABSTRACT

The invention relates to a method and system for video-stream broadcasting of a car race event. The method comprises receiving an input video-stream of the car race event, and receiving a broadcast request for output video-stream comprising geographical location of the user device. The method further comprises providing a content database comprising video content elements associated with geolocation data defining a geographical area. The method further comprises identifying a race car in the input video-stream, generating a video item for the identified race car by selecting a video content element which fulfils the criteria that the video content element is associated with geolocation data defining the geographical area inside which the geographical location of the user device is based on the broadcast request.

### CLAIM TO PRIORITY

This application claims priority to PCT Application Number PCT/IB2024/054436 filed on 7 May 2024, which claims priority to Finnish Application FI-20235584 filed on 26 May 2023, each of which is herein incorporated by reference in its entirety.

### FIELD OF THE INVENTION

The present invention relates to a method for video-stream broadcasting and more particularly to a method according to preamble of claim 1. The present invention also relates to a system for video-stream broadcasting and more particularly to a system according to preamble of claim 22.

### BACKGROUND OF THE INVENTION

In the prior art content in the video-stream broadcast of a car race event has been identical for users. Therefore, the content in the video-stream broadcasts of the car race events has been more relevant to some user than some other users. The race cars and the outer surface thereof is provided information such as the graphical items representing sponsors of the race car or the team operating the race car.

One of the disadvantages associated with the prior art is that the space for presenting information on the outer surface of the race car is very limited. Further, the information on the outer surface of the race car is relevant for only some of the users watching the video-stream broadcast of the car race event.

### BRIEF DESCRIPTION OF THE INVENTION

An object of the present invention is to provide method and system so as to solve or at least alleviate the prior art disadvantages.

The objects of the invention are achieved by a method which is characterized by what is stated in the independent claim 1. The objects of the invention are achieved by a system which is characterized by what is stated in the independent claim 22.

The preferred embodiments of the invention are disclosed in the dependent claims.

The invention is based on the idea of providing a method for video-stream broadcasting of a car race event having multiple race cars, the method being carried out by a computer system in a network having user devices. The method comprises:
a) receiving, in the computer system, an input video-stream of the car race event,
b) receiving, in the computer system, a broadcast request for output video-stream of the car race event from a user device, the broadcast request comprising user data, the user data comprising geolocation information of the user device, the geolocation information defining geographical location of the user device,
c) providing a race car database, the race car database comprising car profile data of each of the race cars of the car race event,
d) providing a content database, the content database comprising video content elements, each video content element being associated with geolocation data, the geolocation data defining a geographical area, and each video content element being associated with car profile data of at least one race car,
e) identifying a race car in the input video-stream, the identifying comprising defining the car profile data of the identified race car,
f) generating a video item for the identified race car based on the one or more identified race cars, the video content elements and the broadcast request, generating video item comprises selecting a video content element which fulfils the following criteria:
   the video content element is associated with the car profile data of the identified race car, and
   the video content element is associated with geolocation data defining the geographical area inside which the geographical location of the user device is based on the broadcast request,
g) fitting the generated video item on the identified race car in the input-video stream to provide a manipulated video data, and
h) broadcasting the manipulated video data as output video-stream from the computer system to the user device as response to the broadcast request.

Accordingly, the method enables providing each race car with individual and geographically targeted video item in the output video-stream based on the geographical location of the user device. Thus, each race car can have for example individual and geographical location specific sponsor information in the output video-stream in the geographical location of the user device.

In some embodiments, in step b) the geolocation information of the user device comprises IP-address of the user device, and in step d) the geolocation data comprises IP-address data defining the geographical area.

The IP-address, or at least part of it, is provided to the broadcast request and the location of the user device may be determined based on the IP-address.

In some other embodiments, in step b) the geolocation information of the user device comprises communication network node data of the user device defining the network node to which the user device is connected, and in step d) the geolocation data comprises communication network data defining the geographical area.

The network node, such as cell tower identifier, to which the user device is connected may be provided to the broadcast request and the location of the user device may be determined based on the network node data.

In some further embodiments, in step b) the geolocation information of the user device comprises navigation satellite system coordinates of the user device, and in step d) the geolocation data comprises navigation satellite system data defining the geographical area.

The navigation satellite system coordinates, such as GPS coordinates, may be provided to the broadcast request and the location of the user device may be determined based on the navigation satellite system coordinates.

In some embodiments, the step e) comprises associating the identified race car to the car profile data representing the identified race car.

Therefore, the identification of the race car comprises associating the identified race car to the car profile data which represents the identified race car. The car profile data comprises information relating to the identified race car.

In some embodiments, in step d) the content database comprises one or more location specific video content elements associated with each car profile data of the race cars, the one or more location specific video content elements being associated with different geolocation data such that each of the one or more location specific video content elements associated with one car profile data is defined for different geographical area.

Accordingly, the content database comprises different video content elements for different geographical areas for the car profile data. Thus, the video content element is selected based on the geographical area in which the user device is located according to the broadcast request.

In some embodiments, the step e) comprises detecting and identifying the race car in the input video-stream during movement of the race car.

Accordingly, the race car may be identified during the race and movement of the race car.

In some other embodiments, the step e) comprises detecting and identifying the race car in the input video-stream during movement of the race car, and the step g) comprises fitting the generated video item on the identified race car in the input-video stream to provide the manipulated video data.

Accordingly, the race car may be identified and the content may be fitted on the identified race car in the input-video stream during the race and movement of the race car. In some embodiments, the step e) comprises providing an object detection algorithm trained to detect and identify the race car in the input video-stream, and utilizing the input video-stream as input data into the object detection algorithm for detecting and identifying the race car in the input video-stream.

The object detection algorithm is trained and configured to the identify the race cars in the input video-stream. The object detection algorithm may be any known type of object detection algorithm such as machine learning algorithm, neural network, statistical detection algorithm or the like. The object detection algorithm may be trained with images of the race cars for providing the trained objection detection algorithm.

In some embodiments, the step f) comprises detecting orientation of the identified race car in the input video-stream.

The orientation of the race car varies in the input video-stream. Therefore, it is important to detect the orientation of the race car in the video-stream such that the video item may be fitted on to the identified race car in appropriate orientation.

In some other embodiments, the step f) comprises providing the object detection algorithm trained to detect orientation of the race car in the input video-stream, and utilizing the input video-stream as input data into the object detection algorithm for detecting the orientation the race car in the input video-stream.

The orientation of the race car may be identified efficiently with the object detection algorithm.

In some embodiments, the step f) comprises calculating orientation for the generated video item based on the detected orientation of the identified race car and generating an oriented video item, and the step g) comprises fitting the oriented video item on the identified race car in the input-video stream to provide the manipulated video data.

Accordingly, the detected orientation of the race car is utilized for calculating the orientation of the video item for providing the oriented video item.

In some embodiments, the video content element is two-dimensional image element.

In some other embodiments, the video content element is partly three-dimensional image element.

In some further embodiments, the video content element is three-dimensional image element.

The three-dimensional image element may be configured to correspond the shape of the race car or part of the shape of the race car. Thus, the video item may be configured to form part of the outer surface of the race car in the output video-stream.

In some embodiments, the video content element is provided as a unique non-fungible token.

In some other embodiments, the video content element is linked to a unique non-fungible token.

In some further embodiments, the video content element is stored with a unique non-fungible token in a blockchain.

The non-fungible token provides the video content element as a unique video content element.

In some embodiments, the car profile data of the race car comprises a three-dimensional helmet model representing a helmet of a driver of the race car.

In some other embodiments, the video content element is provided as a three-dimensional helmet model representing a helmet of the driver of the race car.

The three-dimensional helmet model is a digital three-dimensional helmet model. In some embodiments, the three-dimensional helmet model is a digital twin of the helmet of the driver.

The three-dimensional helmet model may be generated from the helmet for example by scanning or laser scanning, or it may be a technical three-dimensional model of the helmet.

The three-dimensional helmet model may comprise three-dimensional shape of helmet, and possibly also features of the outer surface of the helmet, such as graphical features or visual features.

In some embodiments, the car profile data of the race car comprises a three-dimensional car model representing the race car.

In some other embodiments, the video content element is provided as a three-dimensional car model representing the race car.

The three-dimensional car model is a digital three-dimensional car model. In some embodiments, the three-dimensional car model is a digital twin of the race car.

The three-dimensional car model may be generated from the real car for example by scanning or laser scanning, or it may be a technical three-dimensional model of the race car.

The three-dimensional car model may comprise three-dimensional shape of race car, and possibly also features of the outer surface of the race car, such as graphical features or visual features.

In some other embodiments, the car profile data of the race car comprises a three-dimensional car model representing the race car and a helmet of the driver.

Accordingly, the helmet is considered as an integral part of the car and the three-dimensional car model is configured to represent both the car and the helmet.

In some other embodiments, the video content element is provided as a three-dimensional car model representing the race car and a helmet (5) of the driver.

In some embodiments, the step e) comprises identifying the race car in the input video-stream comprises comparing the race car in the input video-stream to the three-dimensional car model for identifying the race car in the input video-stream.

Accordingly, the three-dimensional car model is utilized in identifying the race car.

In some embodiments, the step f) comprises detecting orientation of the identified race car in the input video-stream by determining the orientation of the race car based on the detected race car in the input video stream and the three-dimensional model of the race car of the identified race car.

Therefore, the three-dimensional car model is utilized for efficiently determining the orientation of the race car in the input video.

In some other embodiments, the step f) comprises detecting orientation of the identified race car in the input video-stream by fitting the three-dimensional model of the race car to the detected race car in the input video-stream and determining the orientation of the fitted three-dimensional model.

The orientation of the race car in the input video is determined by fitting three-dimensional car model to the identified race car, and thus the orientation of the fitted three-dimensional car model represents the orientation of the race car in the input video.

In some embodiments, the three-dimensional car model is provided with an associated video item portion, and the step g) comprises associating the video item to the video item portion of the three-dimensional car model of the identified race car, and the step g) further comprises fitting the three-dimensional car model of the identified race car with the associated video item on the identified race car in the input-video stream to provide the manipulated video data.

Accordingly, the three-dimensional car model is fitted on the identified race car in the input video together with the video item such that the three-dimensional car model replaces the race car in the manipulated video data.

In some embodiments, the step f) comprises calculating the orientation for the generated video item based on the determined orientation of the three-dimensional car model and generating the oriented video item, and the step g) comprises fitting the oriented video item on the identified race car in the input-video stream to provide the manipulated video data.

Accordingly, the orientation of the three-dimensional car model is utilized for calculating the orientation of the video item. The orientation of the video item is configured to be matched with orientation of the three-dimensional car model.

In some other embodiments, the step f) comprises calculating the orientation for the generated video item based on the determined orientation of the three-dimensional car model and generating the oriented video item, and the step g) comprises associating the oriented video item to three-dimensional car model of the identified race car and fitting the three-dimensional car model of the identified race car on the identified race car in the input-video stream to provide the manipulated video data.

Accordingly, in this embodiment the same three-dimensional car model is utilized for different video items. Further, both the three-dimensional car model and the video item are fitted on the identified race car.

In some embodiments, the video content element is provided as the three-dimensional car model representing the race car, the step f) comprises detecting orientation of the identified race car in the input video-stream by determining the orientation of the race car based on the detected race car in the input video stream and the three-dimensional model of the race car of the identified race car, and step g) comprises fitting the three-dimensional car model on the identified race car in the input-video stream to provide the manipulated video data.

Accordingly, in this embodiment there are several different three-dimensional car models for one each race car and each three-dimensional car model is associated with different geolocation data.

In some embodiments, the step a) comprises receiving two or more input video-streams of the car race event, each of the two or more input video streams having an input video-stream identifier.

Accordingly, two or more input video streams are received in the computer system. As each of the input video-streams comprises the input video-stream identifier, the broadcast request may be configured to comprise the input video-stream identifier for broadcasting the output video-stream corresponding the input video-stream identifier. Accordingly, the user may select one video-stream which is further processed according to the present invention.

Alternatively, the method comprises receiving the input video-stream identifier for broadcasting the video stream corresponding the input video-stream identifier. Accordingly, the broadcasted input video-stream is selected based on the received the input video-stream identifier for broadcasting the output video-stream corresponding the input video-stream identifier. The input video-stream identifier may be received for example form a controller device configured to control the broadcast of the car race event.

In some other embodiments, the step a) comprises receiving two or more input video-streams of the car race event, each of the two or more input video-streams having an input video-stream identifier, and the method further comprises carrying out the steps b) to h) for the two or more input video-streams.

In this embodiment, all the input video-streams are processed according to the present invention. The broadcast request may be configured to comprise the input video-stream identifier for broadcasting the video-stream corresponding the input video-stream identifier. Alternatively, the method comprises receiving the input video-stream identifier for broadcasting the output video-stream corresponding the input video-stream identifier.

In some embodiments, the step b) of receiving the broadcast request comprises a broadcast video identifier, the broadcast video identifier being configured to define one of the two or more input video-streams based on the input video-stream identifiers of the two or more input video-streams for defining the input video-stream to be broadcasted to the user device as the output video-stream.

This enables the user to select the input video stream.

In some embodiments, the method comprises carrying out the steps a) to h) for successive image frames of the input video-stream. Thus, the video item is maintained in correct location and orientation on the identified race car in the output video stream.

Accordingly, the video item is fitted on the identifier race car in successive image frames of the input video stream.

Preferably, the steps a) to h) are carried out for every successive image frame of the input video stream.

In some embodiments, embodiments, the method further comprises step i) comprising displaying the output video-stream on a display of the user device in the defined geographical location of the user device.

Accordingly, the method comprises displaying the generated output video with the video item in the geographical location of the user device.

The present invention also relates to a system for video-stream broadcasting of a car race event having multiple race cars. The system comprising a computer system comprising instructions which, when executed on at least one processor of the computer system cause the computer system to perform video-stream broadcasting in a network, and one or more user devices connectable to the computer system in the network. The computer system is configured to:
a) receive an input video-stream of the car race event,
b) receive a broadcast request for output video-stream of the car race event from a user device, the broadcast request comprising user data, the user data comprising geolocation information of the user device, the geolocation information defining geographical location of the user device,
c) provide a race car database, the race car database comprising car profile data of each of the race cars of the car race event,
d) provide a content database, the content database comprising video content elements, each video content element being associated with geolocation data, the geolocation data defining a geographical area, and each video content element being associated with car profile data of at least one race car,
e) identify a race car in the input video-stream, the identifying comprising defining the car profile data of the identified race car,
f) generate a video item for the identified race car based on the one or more identified race cars, the video content elements and the broadcast request, generating video item comprises selecting a video content element which fulfils the following criteria:
   the video content element is associated with the car profile data of the identified race car, and
   the video content element is associated with geolocation data defining the geographical area inside which the geographical location of the user device is based on the broadcast request,
g) fit the generated video item on the identified race car in the input-video stream to provide a manipulated video data, and
h) broadcast the manipulated video data as output video-stream from the computer system to the user device as response to the broadcast request.

Accordingly, the system enables providing each race car with individual and geographically targeted video item in the output video-stream based on the geographical location of the user device. Thus, each race car can have for example individual and geographical location specific sponsor information in the output video-stream in the geographical location of the user device.

In some embodiments, the system is configured to carry out the method according to above disclosed. Accordingly, the system is configured to carry out the method according to the present invention.

An advantage of the invention is that the method and system of the present invention enable customizing individual race cars in the output video-stream for each user based on their geographical location. Therefore, the method and system of the present invention provides geographically relevant information in the race car for users at different geographical areas. Further, each race car may be customized differently.

### BRIEF DESCRIPTION OF THE DRAWINGS

The invention is described in detail by means of specific embodiments with reference to the enclosed drawings, in which

FIG. 1 shows schematically the principle and system of the present invention;

FIG. 2 shows schematically the computer system according to the present invention;

FIGS. 3 and 4 show schematically different embodiments of the present invention;

FIG. 5 shows schematically database structure according to one embodiment of the present invention;

FIG. 6 shows schematically the race car;

FIGS. 7 and 8 show the race car with a fitted video item;

FIGS. 9 and 10 show schematically a three-dimensional race car model; and

FIG. 11 shows schematically the method of the present invention.

### DETAILED DESCRIPTION OF THE INVENTION

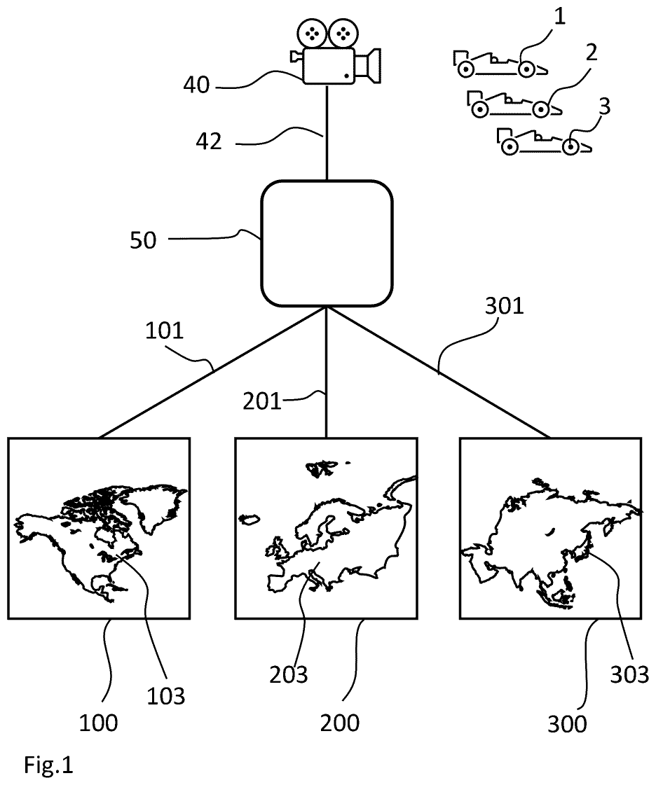

FIG. 1 shows schematically a system according to the present invention. The system comprises at least one imaging device 40, such as a digital camera device, configured to generate an input video-stream of a car race event comprising one or more race cars 1, 2, 3. Therefore, the input video-stream comprises video images of the one or more race cars 1, 2, 3.

The car race event may be a formula race, such as Formula 1, IndyCar or Nascar race, or a rally race or any kind car race event. In the context of this application, for simplicity reasons, the term “car race event” also comprises motorcycle race events comprising one or more motorcycles.

The imaging device 40 is configured to generate the input video-stream, or input video data, of the car race event.

The system further comprises a computer system 50. The computer system 50 is configured to receive the generated input video-stream over a first communication connection 42.

The computer system 50 may comprise one or more servers, which may include cloud sever(s), physical server(s), distributed servers or the like server devices, one or more computers or computer devices. The computer system 50 may be any known type of computer system or computer device or a combination thereof. The present invention is not restricted to any type of computer device 50.

The computer system 50 comprises one or more processors and one or more memories. A software module is stored to the one or more memories. The software module comprises instructions to be carried out by the one or more processors of the computer system 50.

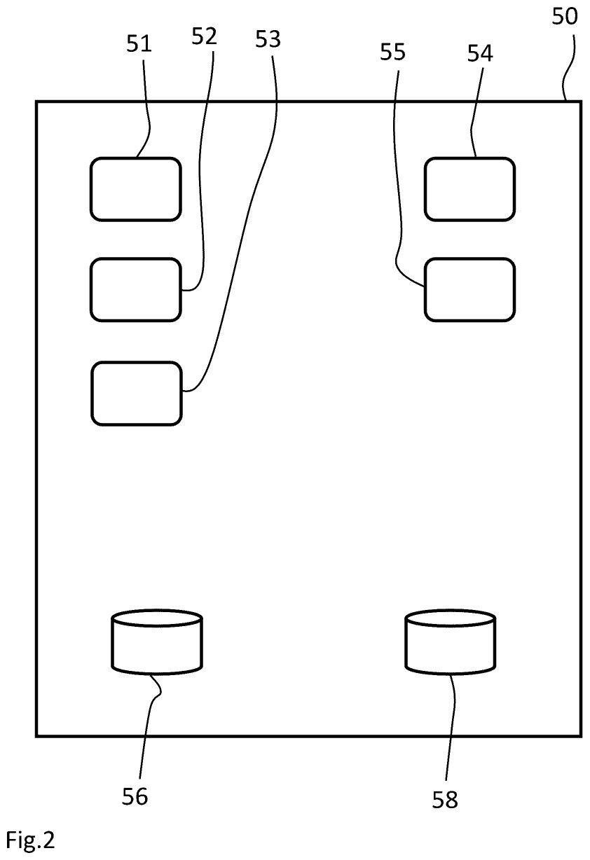

FIG. 2 is a schematic configuration example of the software module which operates the computer system 50. The computer system 50 is configured to carry out the method steps of the present invention by utilizing the software module of the computer system 50.

The computer system 50 and the software module thereof comprises an input unit 51. The input unit 51 is configured to receive the input video-stream. The input unit 51 is configured to receive a broadcast request from a user device or from two or more user devices. The input unit 51 is further configured to receive two or more input video streams from two or more imaging devices 40.

The computer system 50 and the software module thereof comprises an identification unit 53 configured to identify one or more race cars 1, 2, 3 in the input video-stream.

The identification unit 53 comprises an object detection algorithm trained to detect and identify the race car 1, 2, 3 in the input video-stream. The input video-stream is utilized as input data into the object detection algorithm for detecting and identifying the race car 1, 2, 3 in the input video-stream.

In the context of this application, detecting the race car 1, 2, 3 in the input video-stream means that existence of the race car 1, 2, 3 is detected in the input video-stream.

In the context of the present invention identifying the race car 1, 2, 3 in the input video-stream means that it is specifically identified which race car 1, 2, 3 is detected in the input video-stream.

It should be noted that each of race cars 1, 2, 3 is usually different in outer shape or in outer surface visual appearance. Therefore, there is a need to identify the race car 1, 2, 3, meaning which race car or race cars are present in the input video-stream.

The object detection algorithm is trained and configured to the identify the race cars 1, 2, 3 in the input video-stream. The object detection algorithm may be any known type of object detection algorithm such as machine learning algorithm, neural network, statistical detection algorithm or the like. The object detection algorithm may be trained with images or videos or digital models of the race cars 1, 2, 3 for providing the trained objection detection algorithm.

In some embodiments, the object detection algorithm is further configured to detect orientation of the detected race car 1, 2, 3 in the input video-stream. The object detection algorithm may be trained to detect orientation of the race car 1, 2, 3 in the input video-stream.

It should be noted that in some embodiments the object detection algorithm is one algorithm configured to detect the race car 1, 2, 3 in the input video stream, identify the detected race car 1, 2, 3 and further detect the orientation of the identified race car 1, 2, 3. Alternatively, the object detection algorithm may be provided as two, three or more different algorithms which together are configured to carry out together detect the race car 1, 2, 3 in the input video stream, identify the detected race car 1, 2, 3 and further detect the orientation of the identified race car 1, 2, 3.

Further, in some embodiments, the object detection algorithm is not configured to detect the orientation of the race car 1, 2, 3 in the input image.

The object detection algorithm is preferably configured to identify the race car 1, 2, 3 during movement of the race car 1, 2, 3. Accordingly, the race car 1, 2, 3 may identified during the race.

The computer system 50 and the software module thereof further comprises a content generation unit 54 configured to generate a video item for the input video-stream.

The content generation unit 54 is configured to generate the video item based on the identified race car 1, 2, 3 and geolocation information of the user device.

The computer system 50 and the software module thereof further comprises a video processing unit 55 configured to fit the generated video item on the identified race car in the input video-stream to provide a manipulated video data.

In some embodiments, fitting the generated video item on the identified race car in the input video-stream comprises providing a video item overlay or a video item layer on the input video stream for providing the manipulated video data.

Preferably, ting the generated video item on the identified race car 1, 2, 3 in the input video-stream is carried out during movement of the race car 1, 2, 3. Accordingly, the video item is fitted on the identified race car 1, 2, 3 during the race.

The computer system 50 and the software module thereof comprises an output unit 52 configured to broadcast the manipulated video data as an output video-stream from the computer system 50 to the user device as a response to the broadcast request.

The computer system 50 and the software module thereof comprises a race car database 56. The race car database 56 comprises car profile data of each of the race cars 1, 2, 3 of the car race event. Accordingly, each of the race cars 1, 2, 3 of the car race event is provided with a separate car profile data, or race car profile, representing that specific race car 1, 2, 3. The car profile data comprises information of the specific race car.

The computer system 50 and the software module thereof comprises a content database 58. The content database 58 comprises video content elements, each video content element being associated with or comprises geolocation data defining a geographical area. Each video content element is further associated with car profile data of at least one race car 1, 2, 3. Accordingly, each video content element in the content database 58 is associated or provided with geolocation data or geolocation information and car profile data. Thus, the video content elements are race car specific and geographical area specific video content elements.

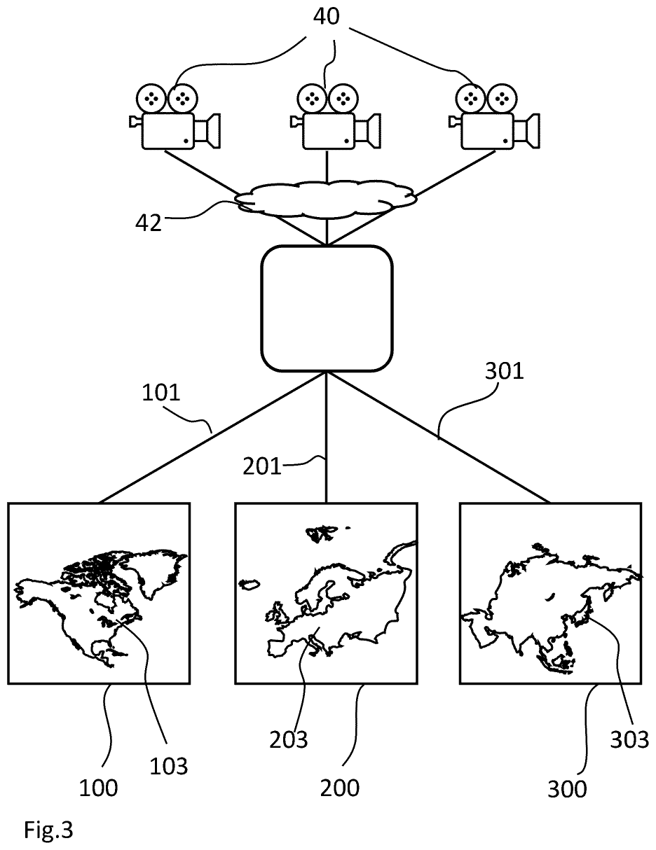

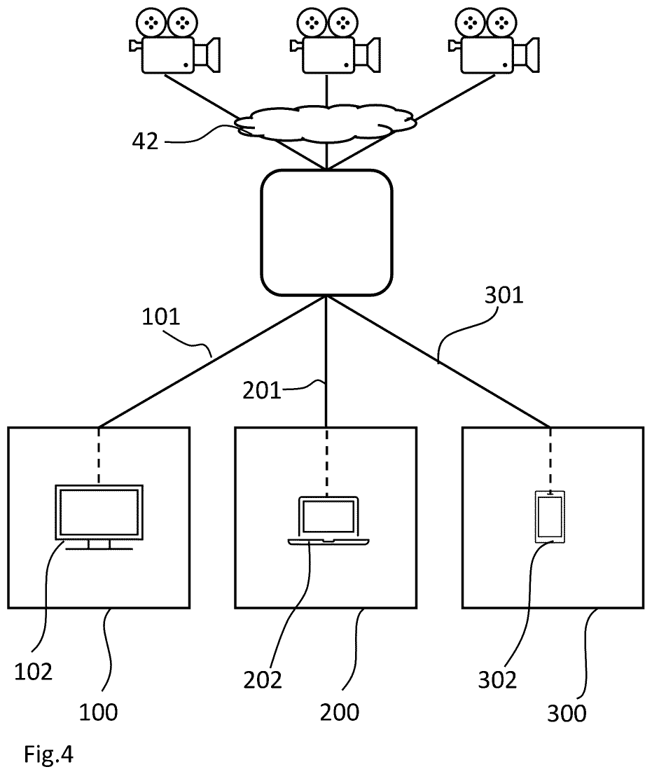

As shown in FIGS. 1 and 3, the input video-stream is received in the input unit 51 of the computer system 50 via the first network connection 42. Further, separate broadcast requests for output video-stream of the car race event are received in the computer system 50 from user devices 102, 202, 302 (FIG. 4) from different geographical locations 103, 203, 303 via second network connections 101, 201, 301, or communication network(s), respectively.

In the embodiment of FIG. 1, only one input video stream is received in the computer system 50 via the first network connection 42 from the imaging device 40.

In the embodiment of FIG. 3, three input video streams are received in the computer system 50 via the first network connection 42 from imaging devices 40.

It should be noted that according to the present invention one or more input video streams may be received in the computer system 50 from one or more imaging devices 40 in any of the embodiments.

The broadcast request comprises a request to receive the output video-stream of the car race event in the user device 102, 202, 302. Each broadcast request comprises user data, and the user data comprises geolocation information of the user device 102, 202, 302. The geolocation information defining geographical location 103, 203, 303 of the user device 102, 202, 302 at the timepoint of transmitting the broadcast request.

Accordingly, each received broadcast request is associated with or comprises the geographical location 103, 203, 303, of the user device 102, 202, 302.

The geolocation information of the user device comprises IP-address of the user device, communication network node data of the user device defining the network node to which the user device is connected, or navigation satellite system coordinates of the user device. In some embodiments, the geolocation information may also comprise some other information defining the geographical location 103, 203, 303 of the user device 102, 202, 302.

It should be noted that according to the present invention one or more broadcast requests may be received in the computer system 50. The computer system 50 is configured to process each of the broadcast requests independently. According to the present invention, the method of the present invention is carried out independently for each of the broadcast requests.

In some embodiments, the computer system 50 is configured group received broadcast requests comprising corresponding or same geographical information defining corresponding or same geographical location of the user devices. The computer system is further configured to process the grouped broadcast requests together or as one broadcast request. Accordingly, the method of the present invention is carried out as in combined manner for the grouped broadcast request.

The imaging device 40 and the computer system, 50 are connected or arranged in communication connection with the first communication connection or with the first communication network 42. Further, the computer system 50 and the user devices 102, 202, 302 are connected or arranged in communication connection with the second communication connections or with the second communication network(s) 101, 201, 301. It should be noted that the first and second communication connections or networks 42, 101, 201, 301 may be separate communication connections or networks or they may be parts of the same communication network.

The communication network 42, 101, 201, 301, for example, may be any one of the Internet, mobile network, a local area network (LAN), or a wide area network (WAN), or some other communication network. In addition, the communication network 42, 101, 201, 301 may be implemented by a combination thereof. The present invention is not restricted to any type of communication network.

In some embodiments, the first and second communication connections or networks 42, 101, 201, 301 are arranged to be parts of a combined communication network.

Accordingly, the computer system 50 comprises a system communication element configured to receive the input video-stream(s) and the broadcast request(s), as well as broadcast the output video-stream. Thus, the system communication element is configured to provide connection to the first communication network 42 and to the second communication network 101, 201, 301.

Further, the imaging device 40, or an imaging system comprising the imaging device 40, comprises an imaging device communication element configured to transmit or send the input video-stream to the computer system 50. Thus, the imaging device communication element is configured to provide connection to the first communication network 42.

The user device 102, 202, 302 may be any kind of user device comprising or a display device, or connected to a separate display device. In the context of this application the wording “display of the user device” refers to both integral display devices of the user device and to external connectable display devices.

The user device may be a mobile phone, smart watch, laptop, tablet computer, smart display, computer, television or any kind user device comprising a display device or connectable to a display device.

The user device 102, 202, 302 comprises a user device communication element configured to transmit or send the broadcast request to the computer system 50 and to receive the output video-stream from the computer system 50. Thus, the user device communication element is configured to provide connection to the second communication network 101, 201, 301.

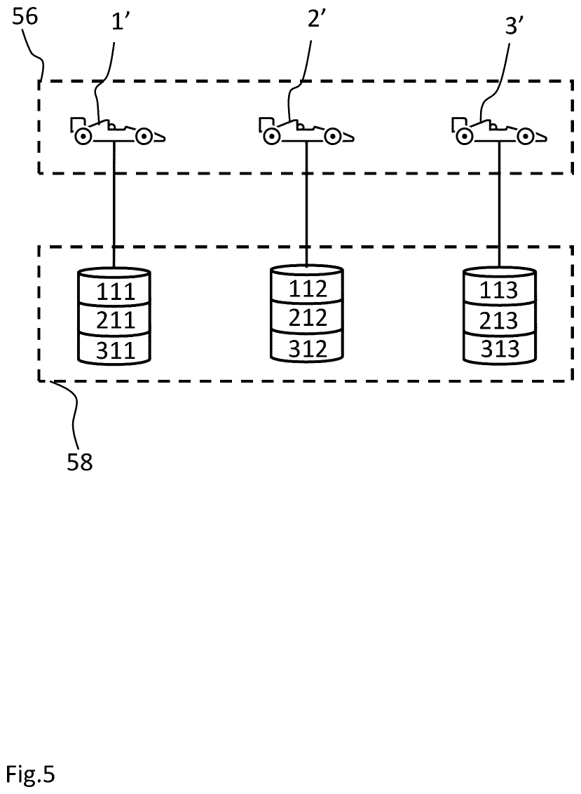

FIG. 5 shows schematically the database structure of the present invention. The database structure comprises the race car database 56 comprising separate car profile data 1′, 2′, 3′ for each of the race cars 1, 2, 3 of the car race event. The car profile data 1′, 2′, 3′ comprises car information of the specific race car 1, 2, 3, respectively.

The content database 58 comprises one or more, preferably two or more, specific video content elements 111, 112, 113, 211, 212, 213, 311, 312, 313 associated or linked or connected to each of the specific car profile data 1′, 2′, 3′, respectively, as shown in FIG. 5. Each specific video content element 111, 112, 113, 211, 212, 213, 311, 312, 313 associated or linked or connected to the specific car profile data 1′, 2′, 3′ is provided with or associated with different geolocation data. The geolocation data defining a specific geographical area 100, 200, 300. Accordingly, each specific video content element 111, 112, 113, 211, 212, 213, 311, 312, 313 is associated or linked or connected to a specific geographical area 100, 200, 300.

Accordingly, each specific video content element 111, 112, 113, 211, 212, 213, 311, 312, 313 which is associated to a specific car profile data 1′, 2′, 3′, is associated or linked or connected to different geographical area 100, 200, 300.

Based on the above disclosed, each car profile data 1′, 2′, 3′ is associated or connected or linked to video content element 111, 112, 113, 211, 212, 213, 311, 312, 313 which is further associated or linked or connected a specific geographical area 100, 200, 300. Therefore, each car profile date 1, 2′, 3′, and thus identified race car 1, 2, 3, is provided with one or more, preferably two or more, geographically targeted or limited to video content elements 111, 112, 113, 211, 212, 213, 311, 312, 313.

For example, in FIG. 5 the first car profile data 1′ is associated with first video content elements 111, 112, 113. Each of the first video content elements 111, 112, 113 is associated or connected or linked with different first geolocation data. Each different first geolocation data is configured to define a different first geographical area 100, 200, 300.

Similarly, the second car profile data 2′ is associated with second video content elements 211, 212, 213. Each of the second video content elements 211, 212, 213 is associated or connected or linked with different second geolocation data. Each different second geolocation data is configured to define a different second geographical area 100, 200, 300.

Further, the third car profile data 3′ is associated with third video content elements 311, 312, 313. Each of the third video content elements 311, 312, 313 is associated or connected to linked with different third geolocation data. Each different third geolocation data is configured to define a different third geographical area 100, 200, 300.

The geographical area 100, 200, 300 of the geolocation data may be any defined geographical area, such as a continent, a country, a city, a part of continent, country or city, any other geographical area.

In the exemplary embodiments of the figures, the first geographical area 100 is North America, the second geographical area 200 is Europe and the third geographical area 300 is Asia.

The computer system 50 is configured to receive the broadcast requests from the user devices 102, 202, 302 located at different geographical locations 103, 203, 303. The broadcast requests comprise the user data. The user data comprises the geolocation information of the user device 102, 202, 302, and the geolocation information is configured to define the geographical location 103, 203, 303 of the user device 102, 202, 302.

As shown in FIGS. 1, 3 and 4, the first user device 102 comprises a first geolocation information in the broadcast request. The first geolocation information is configured to define a first geographical location 103 of the first user device 102. The first geographical location is inside the first geographical area 100.

The second user device 202 comprises a second geolocation information in the broadcast request. The second geolocation information is configured to define a second geographical location 203 of the second user device 202. The second geographical location is inside the second geographical area 200.

Further, the third user device 302 comprises a third geolocation information in the broadcast request. The third geolocation information is configured to define a third geographical location of the third user device 302. The third geographical location is inside the third the third geographical area 300.

In the content database 58, each of the first video content elements 111, 112, 113, associated with the first car profile data 1′, are each associated or connected or linked to a different geolocation data and further to a different geographical area 100, 200, 300. One first video content element 111 is associated or connected or linked to the geolocation data configured to define or represent the first geographical area 100. Another first video content element 112 is associated or connected or linked to the geolocation data configured to define or represent the second geographical area 200. Further, yet another first video content element 113 is associated or connected or linked to the geolocation data configured to define or represent the third geographical area 300.

Similarly, in the content database 58, each the second video content elements 211, 212, 213, associated with the second car profile data 2′, are each associated or connected or linked to a different geolocation data and further to a different geographical area 100, 200, 300. One second video content element 211 is associated or connected or linked to the geolocation data configured to define or represent the first geographical area 100. Another second video content element 212 is associated or connected or linked to the geolocation data configured to define or represent the second geographical area 200. Further, yet another second video content element 213 is associated or connected or linked to the geolocation data configured to define or represent the third geographical area 300.

Further, in the content database 58, each the third video content elements 311, 312, 313, associated with the third car profile data 3′, are each associated or connected or linked to a different geolocation data and further to a different geographical area 100, 200, 300. One third video content element 311 is associated or connected or linked to the geolocation data configured to define or represent the first geographical area 100. Another third video content element 312 is associated or connected or linked to the geolocation data configured to define or represent the second geographical area 200. Further, yet another third video content element 313 is associated or connected or linked to the geolocation data configured to define or represent the third geographical area 300.

Upon receiving the input video-stream from the imaging device 40 via the input unit 51 of the computer system 50, the input video-stream is inputted to the identification unit 53. The identification unit 53 is configured to detect and identify the specific race car 1, 2, 3 in the input video-stream. As a response to the detecting and identifying the specific race car 1, 2, 3 in the input video-stream the computer system 50 is configured to associate or connect or link the identified race car 1, 2, 3 to the specific car profile data 1′, 2′, 3′ corresponding the identified race car 1, 2, 3.

Associating or connecting or linking the identified race car 1, 2, 3 to the specific car profile data 1′, 2′, 3′ corresponding the identified race car 1, 2, 3 may be carried out based on the identification output of the identification unit 53 and the car profile data 1′, 2′, 3′, or based on the output of the object detection algorithm and the car profile data 1′, 2′, 3′.

The computer system 50 is configured to receive the broadcast request from the one or more user devices 102, 202, 302. Each broadcast request is provided with the user data comprising geolocation information of the user device 102, 202, 302. The geolocation information defining the geographical location 103, 203, 303 of the user device 102, 202, 302.

In the embodiment of the figures and as disclosed above, the first user device 102 comprises the first geolocation information defining the first geographical location 103 of the first user device 102. The second user device 202 comprises the second geolocation information defining the second geographical location 203 of the second user device 202. The third user device 302 comprises the third geolocation information defining the third geographical location 303 of the third user device 302.

The race car 1, 2, 3 is detected and identified by the identification unit 53 of the computer system 50.

In the following it is defined that the detected and identified race car is the second race car 2. However, it should be noted that the identification unit 53 may also detect and identify two or more race cars 1, 2, 3 at the same time, or any of the race cars 1, 2, 3 of the car race event.

The identified second race car 2 is associated with the second car profile data 2′ based on the identifying the second race car 2 and the second car profile data 2′.

According to the present invention the computer system 50 is configured to generate a different output video-stream for different geographical areas 100, 200, 300 based on the broadcast requests and the geolocation information of the broadcast requests.

First, the computer system 50 and the content generation unit 54 thereof is configured to select a second video content element 211, 212, 213 which is associated with the second car profile data 2′ of the identified second race car 2. The video content generation unit 54 is further configured to select the second video content element 211, 212, 213 which is associated with geolocation data defining the geographical area 100, 200, 300 inside which the geographical location of the user device 102, 202, 302 is based on the broadcast request.

Accordingly, in the embodiment of FIGS. 1 to 5, the content generation unit 54 is configured to select the video content element 211 for the first broadcast request form the first user device 102 based on that the geographical location 103 of the first user device 102 is within the first geographical area 100. Similarly, the content generation unit 54 is configured to select the video content element 212 for the second broadcast request from the second user device 202 based on that the geographical location 203 of the second user device 202 is within the second geographical area 200. Further, the content generation unit 54 is configured to select the video content element 213 for the third broadcast request from the third user device 302 based on that the geographical location 303 of the third user device 302 is within the third geographical area 200.

In some embodiments, the content generation unit 54 is configured to generated, for example utilizing artificial intelligence generation model, the video content element for the broadcast request from the user device based on the geographical location of the user device 102 and based on a video content template or video content description stored in the content database.

Then the computer system 50 and the video processing unit 55 thereof is configured to fit the generated video item 211 on the identified second race car 2 in the input-video stream to provide a first manipulated video data. The computer system 50 and the output unit 52 thereof is further configured broadcast the first manipulated video data as a first output video-stream from the computer system 50 to the first user device 102 as response to the first broadcast request.

Similarly, the computer system 50 and the video processing unit 55 thereof is configured to fit the generated video item 212 on the identified second race car 2 in the input-video stream to provide a second manipulated video data. The computer system 50 and the output unit 52 thereof is further configured broadcast the second manipulated video data as a second output video-stream from the computer system 50 to the second user device 202 as response to the second broadcast request.

Further, the computer system 50 and the video processing unit 55 thereof is configured to fit the generated video item 213 on the identified second race car 2 in the input-video stream to provide a third manipulated video data. The computer system 50 and the output unit 52 thereof is further configured broadcast the third manipulated video data as a third output video-stream from the computer system 50 to the third user device 302 as response to the third broadcast request.

Fitting the generated video item on the detected and identified race car may be carried out with a fitting algorithm which is configured to fit the generated video item on the race car based on the detection of the race car in the input video-stream, or based on the output of the identification unit 53, or based on the output of the object detection algorithm.

In some embodiments, the identification unit 53 or the object detection algorithm thereof is configured to detect the border lines or surfaces of the race car in the input video-stream. Fitting the generated video item on the detected and identified race car is then carried out with a fitting algorithm which is configured to fit the generated video item on the race car based on the detected border lines or surfaces of the race car by the identification unit 53 or the object detection algorithm.

In some embodiments, fitting the generated video item on the detected and identified race car by the computer system comprises providing a video item layer comprising the generated video item, and combining the video item layer and the input video-stream for fitting the generated video item on the race car such that the manipulated video data is provided.

In some embodiments, fitting the generated video item on the detected and identified race car by the computer system comprises splitting the input video-stream into a race car layer and a background layer, the race car layer comprising the detected race car and the background layer comprising image data outside the detected race car. The fitting further comprises fitting the generated video item on the detected race car in the race car layer, and combining the background layer and the race car layer to provide the manipulated video data.

In some embodiments, fitting the generated video item on the detected and identified race car by the computer system comprises splitting the input video-stream into a first race car layer, a second race car layer and a background layer. The first race car layer comprises the first detected race car, the second race car layer comprises the second detected race car and the background layer comprises image data outside the detected first and second race cars. The fitting further comprises fitting the first generated video item on the first detected race car in the first race car layer, fitting the second generated video item on the second detected race car in the second race car layer, and combining the background layer, the first race car layer and the second race car layer to provide the manipulated video data.

The orientation of the race car varies in the input video-stream. Accordingly, the race car is detected from different or varying viewing angles in the input video-stream as the race cars 1, 2, 3 move often in relation to the imaging device 40. Therefore, it is important to detect the orientation of the race car in the video-stream such that the generated video item may be fitted on to the identified race car in appropriate orientation.

In the context of this application the orientation of the race car means viewing angle of the race car 1, 2, 3 in the input video-stream.

Accordingly, the computer system 50 and the identification unit 53 or the content generation unit 54 thereof is configured to detect the orientation of the race car 1, 2, 3 in the input video stream.

In some embodiments, identifying the race car 1, 2, 3 in the input video-stream in the identification unit 53 comprises detecting the orientation of the race car 1, 2, 3 in the input video stream.

Thus, identifying the race car 1, 2, 3 in the input video-stream in the identification unit 53 may comprise providing the detection algorithm trained to detect orientation of the race car in the input video-stream, and utilizing the input video-stream as input data into the object detection algorithm for detecting the orientation the race car in the input video-stream. Detecting the orientation may be carried out with same or separate object detection algorithm as detecting the race car in the input video-stream and/or identifying the race car 1, 2, 3 in the input video-stream. Alternatively, the identification unit 53 may comprise a separate object orientation detection algorithm.

In some other embodiments, generating the video item in the content generation nit 54 comprises detecting the orientation of the race car 1, 2, 3 in the input video stream.

Thus, generating the video item in the content generation unit 54 may comprise providing the orientation detection algorithm trained to detect orientation of the race car in the input video-stream, and utilizing the input video-stream as input data into the orientation detection algorithm for detecting the orientation the race car in the input video-stream.

Then, the generated video item needs to be oriented according to the orientation of the race car.

Accordingly, generating the video item in the content generation unit 54 comprises calculating orientation for the generated video item based on the detected orientation of the identified race car and generating an oriented video item based on the calculation.

In some embodiments, generating the video item in the content generation unit 54 comprises calculating orientation for the generated video item based on an output of the object detection algorithm or orientation detection algorithm and generating the oriented video item based on the calculation.

Accordingly, the detected orientation of the race car is utilized for calculating the orientation of the video item for providing the oriented video item.

The orientation of the oriented video item is configured to correspond the orientation of the race car in the input video stream.

Then, the oriented video item is fitted on the identified race car in the input-video stream to provide the manipulated video data. Therefore, the video item is fitted in the same orientation as the race car 1, 2, 3 is detected.

FIG. 6 shows schematically the race car 1.

In the context of the present application, the race car may comprise the race car 1 or the race car 1 and the helmet 5 of the driver.

In formula cars the helmet 5 of the driver is usually fixed to the car directly or via a neck support. Thus, the helmet 5 may be considered as an integral part of the race car.

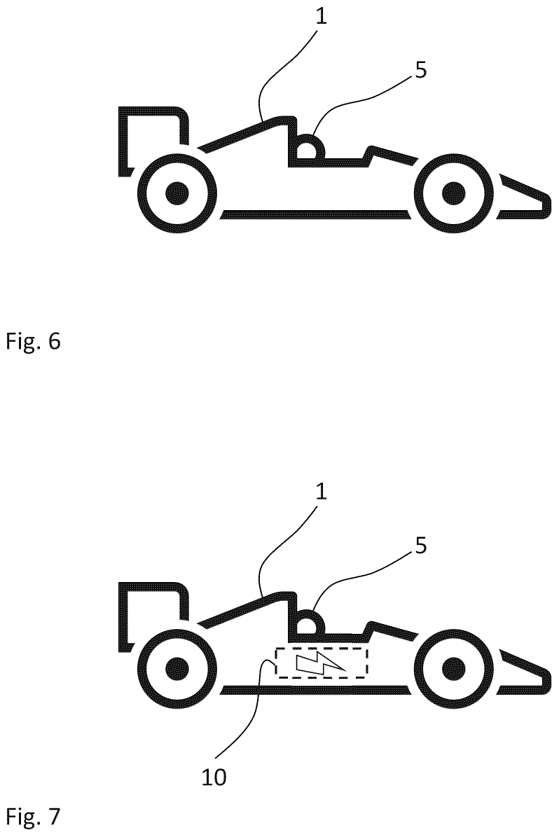

The video content element may be separate video content element 10 which is configured to be fitted on a part of the race car 1, 2, 3 or outer surface thereof, as shown in FIG. 7.

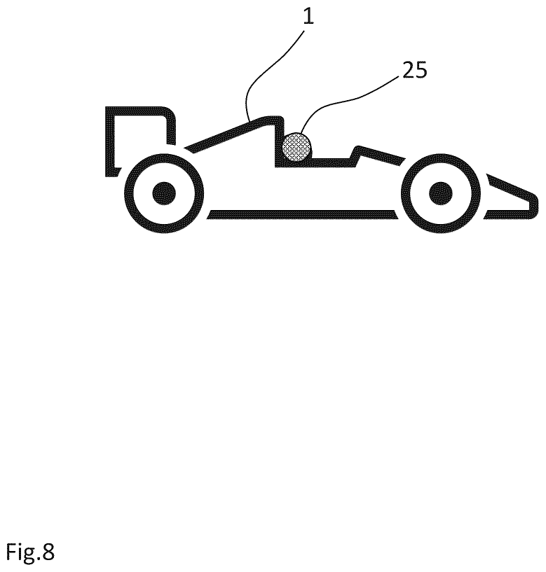

FIG. 8 shows an embodiment in which the video content element is provided as a three-dimensional helmet model 25 representing the helmet 5 of the driver of the race car 1.

In some embodiments, the video content element 25 is a three-dimensional image element configured to correspond the shape of the helmet 5.

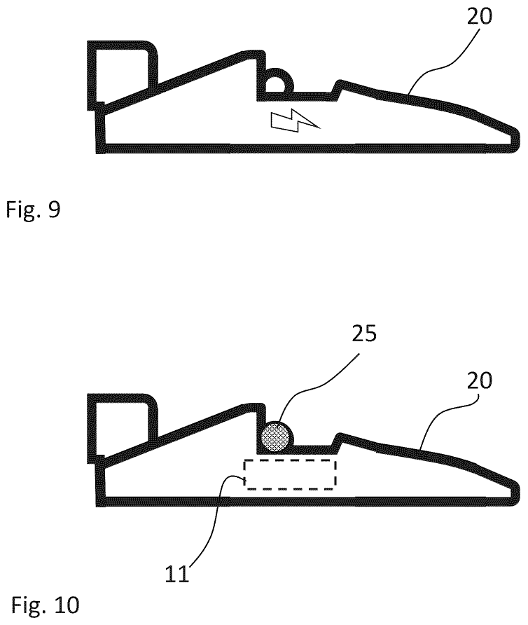

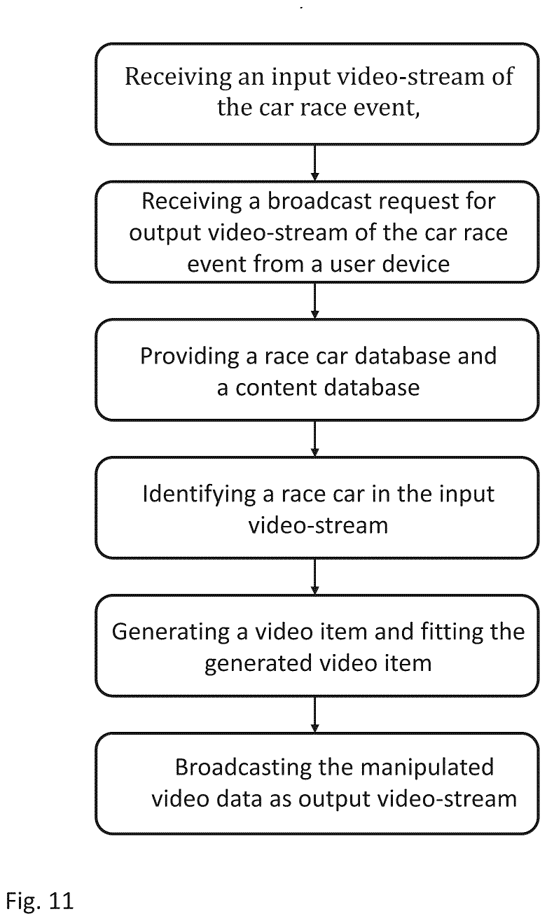

FIG. 9 shows an alternative embodiment in which the video content element 20 is a three-dimensional image element configured to correspond the shape of the race car or part of the shape of the race car. Thus, the video item 20 may be configured to form part of the outer surface of the race car 1, 2, 3 in the output video-stream. Accordingly, the video content element 20 may be a three-dimensional car model representing the race car, as shown in FIG. 9. Accordingly, there may two or more three-dimensional car models 20 as the video content elements with different geolocation information.

FIG. 10 shows a further embodiment, in which the race car database 56 and the car profile data comprises three-dimensional car model 20 representing the race car. The content database further comprises separate video content elements 10.

The three-dimensional car model 20 is provide with an associated video item portion 11 as shown in FIG. 10.

In some embodiments, the car model 20, or the three-dimensional car model 20, comprises the helmet, or a three-dimensional helmet model 25. The content database further comprises separate video content elements which may fitted to the car model 20 or to the helmet model 25.

The helmet model 25 may be provided as the video item portion 11. In some embodiments, the identifying in the identification unit 53 comprises comparing the race car in the input video-stream to the three-dimensional car model 20 for identifying the race car in the input video-stream.

Accordingly, the three-dimensional car model is utilized in identifying the race car.

In some further embodiments, detecting the orientation of the identified race car in the input video-stream comprises determining the orientation of the race car based on the detected race car in the input video stream and the three-dimensional model 20 of the race car of the identified race car.

Accordingly, the orientation of the three-dimensional model 20 may be adjusted such that the orientation the three-dimensional model 20 corresponds the orientation of the race car in the input video-stream. Thus, the three-dimensional model 20 may be fitted on the race car 1, 2, 3 in the input video-stream by adjusting the orientation the three-dimensional model 20 to correspond the orientation of the race car 1, 2, 3 in the input video-stream.

Therefore, the three-dimensional car model is utilized for efficiently determining the orientation of the race car in the input video.

In some embodiments, the orientation of the generated video item is calculated based on the determined three-dimensional car model 20.

In some embodiments, the three-dimensional model 20 is fitted on the race car in the input video-stream for providing the manipulated video data.

In some embodiments, the video item 10 is fitted on the three-dimensional model 20.

In some embodiments the video item 10 is fitted on the three-dimensional model 20 and on the associated video item portion 11 of the three-dimensional model 20.

The orientation of the race car in the input video is determined by fitting three-dimensional car model to the identified race car, and thus the orientation of the fitted three-dimensional car model represents the orientation of the race car in the input video.

In preferred embodiments, of the present invention the steps of generating the manipulated video data are carried out for each video frame of the input video stream.

The manipulated video data as output video-stream is broadcasted by the computer system 50 via the output unit 52 to the user device 102, 202, 302 based on the broadcast request.

The user device 102, 202, 302 is configured to receive the broadcasted output video-stream. The user device 102, 202, 302 is further configured to display the output video-stream on a display of the user device 102, 202, 302 in the defined geographical location 103, 203, 303 of the user device 102, 202, 302, respectively.

Accordingly, the generated output video with the video item is displayed in the geographical location of the user device.

FIG. 9 discloses the main steps of the method of the present invention.

The invention has been described above with reference to the examples shown in the figures. However, the invention is in no way restricted to the above examples but may vary within the scope of the claims.

1. A method for video-stream broadcasting of a car race event having multiple race cars, the method being carried out by a computer system in a network having user devices, wherein the method comprises:
receiving, by the computer system, an input video stream of the car race event,
receiving, by the computer system, from a user device, a broadcast request for an output video-stream of the car race event, the broadcast request comprising user data, the user data comprising geolocation information of the user device, the geolocation information defining a geographical location of the user device,
identifying, by the computer system, a first race car in the input video stream, the identifying comprising defining car profile data of the first race car based on a race car database, comprising car profile data of each of the race cars of the car race event,
generating, by the computer system, a video item for the first race car based on the first car profile data, at least one video content element and the broadcast request, wherein the at least one video content element is associated with:
the car profile data of the identified race car, and
geolocation data defining a geographical area inside which is the geographical location of the user device based on the broadcast request,
fitting, by the computer system, the generated video item on the first race car in the input video stream to provide a manipulated video data, the fitting comprising:
determining an orientation of the first race car in the input video stream using at least one object detection algorithm,
modifying a video item orientation of the video item based at least in part on the orientation of the first race car, and
applying, based on the video item orientation, the video item to at least one surface on the first race car in the video data to produce the manipulated video data, and
broadcasting, by the computer system, the manipulated video data as the output video-stream from the computer system to the user device in response to the broadcast request.

2. A method according to claim 1, wherein:
the geolocation information of the user device comprises IP-address of the user device, and the geolocation data comprises IP-address data defining the geographical area; or
the geolocation information of the user device comprises communication network node data of the user device defining the network node to which the user device is connected, and the geolocation data comprises communication network data defining the geographical area; or
the geolocation information of the user device comprises navigation satellite system coordinates of the user device, and the geolocation data comprises navigation satellite system data defining the geographical area.

3. A method according to claim 1, further comprising associating, by the computer system, the first race car to the car profile data representing the first race car.

4. A method according to claim 1, wherein the at least one video content element comprises one or more location specific video content elements associated with each car profile data of the race cars, the one or more location specific video content elements being associated with different geolocation data.

5. A method according to claim 1, further comprising:
detecting and identifying, by the computer system, the race car in the input video stream during movement of the race car; or
detecting and identifying, by the computer system, the race car (1, 2, 3) in the input video stream during movement of the race car, and
fitting, by the computer system, the generated video item on the first race car in the input video stream to provide the manipulated video data.

6. A method according to claim 1, further comprising:
providing, by the computer system, an object detection algorithm trained to detect and identify the race car in the input video stream, and
utilizing, by the computer system, the input video stream as input data into the object detection algorithm for detecting and identifying the race car in the input video stream.

7. A method according to claim 1, further comprising:
detecting, by the computer system, orientation of the first race car in the input video stream; or
providing, by the computer system, the object detection algorithm trained to detect orientation of the race car in the input video stream, and
utilizing, by the computer system, the input video stream as input data into the object detection algorithm for detecting the orientation the race car in the input video stream.

8. A method according to claim 7, further comprising:
calculating, by the computer system, orientation for the generated video item based on the detected orientation of the first race car;
generating, by the computer system, an oriented video item; and
fitting, by the computer system, the oriented video item on the first race car in the input video stream to provide the manipulated video data.

9. A method according to claim 1, wherein:
the video content element is two-dimensional image element; or
the video content element is partly three-dimensional image element; or
the video content element is three-dimensional image element.

10. A method according to claim 1, wherein:
the video content element is provided as a unique non-fungible token; or
the video content element is linked to a unique non-fungible token; or
the video content element is stored with a unique non-fungible token in a blockchain.

11. A method according to claim 1, wherein:
the car profile data of the race car comprises a three-dimensional helmet model representing a helmet of a driver of the race car; or
the video content element is provided as a three-dimensional helmet model representing a helmet of the driver of the race car.

12. A method according to claim 1, wherein:
the car profile data of the race car comprises a three-dimensional car model representing the race car; or
the video content element is provided as a three-dimensional car model representing the race car; or
the car profile data of the race car comprises a three-dimensional car model representing the race car and a helmet of a driver; or
the video content element is provided as a three-dimensional car model representing the race car and a helmet of the driver.

13. A method according to claim 12, further comprising comparing, by the computer system, the race car in the input video stream to the three-dimensional car model for identifying the race car in the input video stream.

14. A method according to claim 12, further comprising:
detecting, by the computer system, the orientation of the first race car in the input video stream by determining the orientation of the race car based on the detected race car in the input video stream and the three-dimensional model of the race car of the first race car; or
detecting, by the computer system, the orientation of the first race car in the input video stream by fitting the three-dimensional model of the race car to the detected race car in the input video stream and determining the orientation of the fitted three-dimensional model.

15. A method according to claim 12, further comprising:
associating, by the computer system, the video item to a video item portion of the three-dimensional car model of the first race car, wherein the three-dimensional car model is provided with the video item portion; and
fitting, by the computer system, the three-dimensional car model of the first race car with the associated video item on the first race car in the input video stream to provide the manipulated video data.

16. A method according to claim 14, further comprising:
performing steps comprising:
calculating, by the computer system, the orientation for the generated video item based on the determined orientation of the three-dimensional car model and generating the oriented video item; and
fitting, by the computer system, the oriented video item on the first race car in the input video stream to provide the manipulated video data; or
performing steps comprising:
calculating, by the computer system, the orientation for the generated video item based on the determined orientation of the three-dimensional car model;
associating, by the computer system, the oriented video item to three-dimensional car model of the first race car to generate the oriented video item; and
fitting, by the computer system, the three-dimensional car model of the first race car on the first race car in the input video stream to provide the manipulated video data.

17. A method according to claim 1, further comprising:
detecting, by the computer system, the orientation of the first race car in the input video stream by determining the orientation of the race car based on the detected race car in the input video stream and a three-dimensional model of the first race car,
wherein the video content element is provided as the three-dimensional car model representing the race car, and
fitting, by the computer system, the three-dimensional car model on the first race car in the input video stream to provide the manipulated video data.

18. A method according to claim 1, further comprising:
receiving, by the computer system, the input video stream comprising two or more input video streams of the car race event, each of the two or more input video streams having an input video stream identifier.

19. A method according to claim 18, further comprising receiving, by the computer system, the broadcast request comprising a broadcast video identifier, the broadcast video identifier being configured to define one of the two or more input video streams based on the input video stream identifiers of the two or more input video streams for defining the input video stream to be broadcasted to the user device.

20. A method according to claim 1, further comprising carrying out the steps, by the computer system, to produce the manipulated video data for successive image frames of the input video stream.

21. A method according to claim 1, further comprising displaying, by the computer system, the output video-stream on a display of the user device in the defined geographical location of the user device.

22. A system for video-stream broadcasting of a car race event having multiple race cars, the system comprising a computer system comprising instructions which, when executed on at least one processor of the computer system cause the computer system to perform video-stream broadcasting in a network, and one or more user devices connectable to the computer system in the network, characterized in that the computer system is configured to:
receive an input video stream of the car race event,
receive, from a user device, a broadcast request for an output video-stream of the car race event from a user device, the broadcast request comprising user data, the user data comprising geolocation information of the user device, the geolocation information defining geographical location of the user device,
identify a first race car in the input video stream, the identifying comprising defining car profile data of the first race car based on a race car database, comprising car profile data of each of the race cars of the car race event,
generate a video item for the first race car based on the first car profile data, at least one video content element and the broadcast request, wherein the at least one video content element is associated with:
the car profile data of the first race car, and
geolocation data defining a geographical area inside which the geographical location of the user device based on the broadcast request,
fit the generated video item on the first race car in the input video stream to provide a manipulated video data, the fitting comprising:
determining an orientation of the first race car in the input video stream using at least one object detection algorithm,
modifying a video item orientation of the video item based at least in part on the orientation of the first race car, and
applying, based on the video item orientation, the video item to at least one surface on the first race car in the video data to produce the manipulated video data, and
broadcast the manipulated video data as the output video-stream from the computer system to the user device in response to the broadcast request.
